(19) United States
(12) Patent Application Publication
(10) Pub. No.: US 2007/0150416 A1
(43) Pub. Date: Jun. 28, 2007

(54) Systems and methods for copy protection during multi-factor authenticating of electronic transactions

(76) Inventor: Kevin Wayne Friedman, St. Ives (AU)

Correspondence Address: BAKER & MCKENZIE LLP;PATENT DEPARTMENT, 2001 ROSS AVENUE, SUITE 2300, DALLAS, TX, 75201, US

(21) Appl. No.: 11/292,263

(22) Filed: Dec. 1, 2005

(51) Int. Cl. G06Q 99/00

(52) U.S. Cl. 705/57

(57) ABSTRACT

A specially configured payment card that functions as both a standard payment, e.g., bank credit, debit, or ATM card for use in point-of-purchase transactions and an optical storage device that can be read by any common CD or DVD drive for use in secure online E-Commerce transactions. In order to prevent copying of the data stored in the optical storage media, a code can be included in the Absolute Time In Pregroove (ATIP) area of the optical media. This code can be used in order to protect against the use of counterfeit cards in online transactions.

### RELATED APPLICATION INFORMATION

This application is related to U.S. patent application Ser. No. 10/347,114, entitled “Token For Use in Electronic Online and Offline Transactions”, filed Jan. 16, 2003, which is a continuation of U.S. patent application Ser. No. 10/338,822, entitled “Systems and Methods for Secure Authentication of Electronic Transactions,” filed Jan. 7, 2003, both of which are incorporated herein in the entirety as if set forth in full.

### BACKGROUND

1. Field of the Inventions

The field of the invention relates generally to electronic transactions, and more particularly to authentication of such transactions using a token configured to work in conjunction with a standard input device.

2. Background Information

Internet based financial transactions, referred to generally as “E-Cornmerce”, are currently experiencing very rapid growth, due primarily to its convenience compared with telephonic or point-of-purchase transactions. In response to growing abuse, E-Commerce has developed various Web-specific methods in attempts to ensure security and prevent fraud. One aspect of E-Commerce that remains particularly vulnerable is in regard to identity verification. Identification in point-of-purchase transactions is inferred by physical possession of the payment card, and may also include a second-factor, i.e., some more direct type of identification, such as a picture ID in face-to-face transactions. Obviously, these identification measures are not possible with telephone and E-Commerce based transactions where all that is typically needed to carry out a transaction is the information anyone could have obtained by a quick visual inspection of a person's payment card. The fact that E-Commerce purchases can be carried out without an individual actually having a payment card physically in their possession, coupled with the inability to verify user identity creates a significant opportunity for fraud. Some E-Commerce merchants now require supplemental identification, usually a billing address, Personal Identification Number (PIN), or a similar item of card holder identification not found on the credit card per se. While this provides some added degree of verification, it falls far short of ensuring physical possession of the credit card by the purchaser.

The increasing use of payment cards by consumers, particularly in the E-Commerce environment, has stimulated intense interest in the development of cards with enhanced functionality and security. A key feature of these enhanced cards is their significantly increased data storage capacity compared with the standard magnetic stripe, which has less than one kilobyte of storage capacity. Most of these so-called “smartcards” rely on a silicon memory chip embedded in the card that provides several kilobytes of data storage and which may even include an onboard microprocessor. Smartcards may use one or more memory types, including ROM, PROM, EPROM, EEPROM, or RAM. Each of these memory types enables certain finctionalities and security features.

Payment cards with enhanced data storage capability in the form of optical storage, or other storage mechanisms, are also known. Such cards have the potential to provide, in addition to enhanced functionality, the ability for physical card verification in the form of a hardware key or token. A significant drawback to the general acceptance of all these cards for E-Commerce, however, is the requirement for a specialized single-purpose piece of hardware or “reader” that allows the user to interface the card with a mini-computer. Thus, there currently exists no convenient and portable means for direct physical payment card verification in the E-Commerce environment. For this reason, such cards, i.e., smartcards, have found minimal acceptance in the U.S. The result is a much higher rate of fraud in E-Commerce compared with direct face-to-face transactions, which inflicts a financial hardship on merchants and has a chilling effect on the acceptance of E-Commerce by consumers.

### SUMMARY OF THE INVENTION

A specially configured payment card that functions as both a standard payment, e.g., bank credit, debit, or ATM card for use in point-of-purchase transactions and an optical storage device that can be read by any common CD or DVD drive for use in secure online E-Commerce transactions. In order to prevent copying of the data stored in the optical storage media, a code can be included in the Absolute Time In Pregroove (ATIP) area of the optical media. This code can be used in order to protect against the use of counterfeit cards in online transactions.

These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 is a diagram illustrating an online transaction system in accordance with an example embodiment;

FIG. 2 is a diagram illustrating an example embodiment of a token configured in the form factor of a mini-CD;

FIGS. 3A and 3B is are views illustrating an example embodiment of a token configured in the form factor of a typical payment card and with an accompanying carrier; and

FIG. 4 is a diagram illustrating an example embodiment of a token configured in the form factor of a typical payment card comprising two layers;

FIGS. 5A and 5B are views illustrating an example embodiment of a optical payment card configured to be compatible with card readers and optical media drives without the use of a carrier;

FIG. 6 is a diagram illustrating an example embodiment of a optical payment card configured with an added personalization layer;

FIG. 7 is a diagram illustrating a cross section of a typical optical media disk;

FIGS. 8A, 8B and 8C are ray geometry drawings illustrating the focusing of a laser beam in a typical optical media disk, an optical payment card, and an optical payment card offset a distance from the optical input device laser;

FIG. 9A and 9B are ray geometry drawings illustrating the displacement of the focal point in an off-center focusing environment for both a typical optical media disk and an optical payment card with height compensation; and

FIG. 10 is a diagram illustrating an example method for copy protection in accordance with one embodiment.

### DETAILED DESCRIPTION OF THE PREFERRED EMBODIMENTS

To help better understand the systems and methods described herein, some specific examples involving electronic commerce over the Internet, i.e., online transactions, are examined below. It should be remembered, however, that the examples provided are not intended to limit the systems and methods described to electronic commerce or Internet implementations. Rather, the systems and methods described can be implemented for any type of electronic transaction that requires authentication.

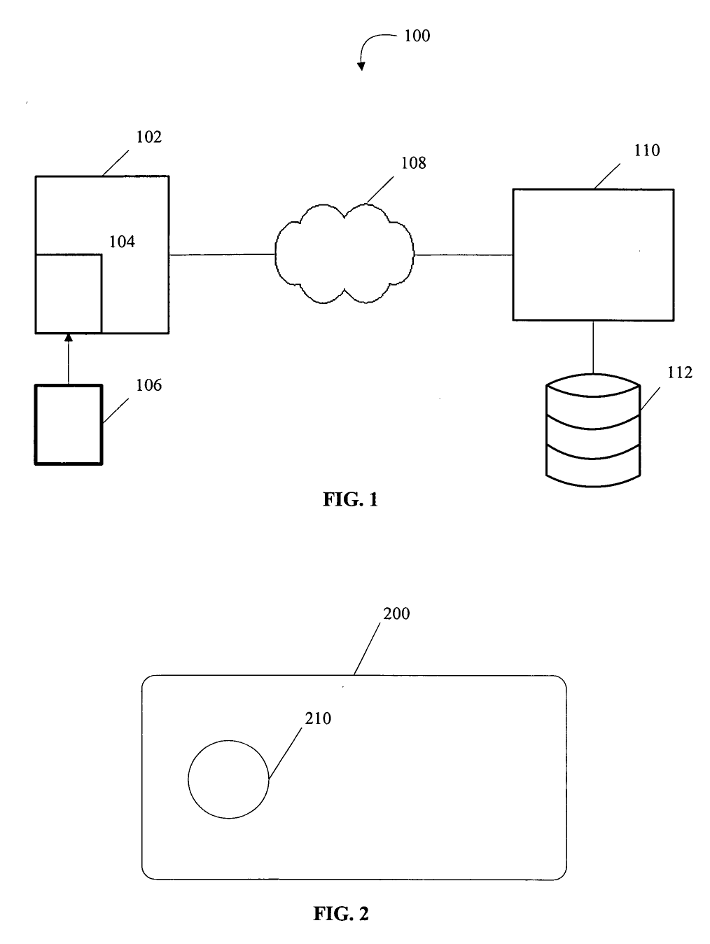

FIG. 1 is a diagram illustrating an example embodiment of an online transaction system 100 configured in accordance with one embodiment of the systems and methods described herein. System 100 comprises a terminal 102 that is configured to engage in an online transaction. Terminal 102 can also be configured to communicate through a communication network 108 with an authentication authority 110 configured to authenticate the electronic transaction. Network 108 can also be used to engage in the online transaction. Alternatively, terminal 102 can be configured to engage in the online transaction over another network.

Network 108 can, for example, be the Internet, but it can also be some other type of network. Network 108 can, for example, be a wired, or wireless Wide Area Network (WAN), such as a telephone network, a wired, or wireless Metropolitan area Network (MAN), a wired, or wireless Local Area Network (LAN) or even a wired, or wireless Personal Area Network (PAN).

Accordingly, terminal 102 can be any type of terminal configured to communicate over any of the above networks. In one particular embodiment that is discussed in detail below, terminal 102 can be any terminal configured to communicate over the Internet, such as a personal computer, laptop computer, cable set-top box, Internet enabled phone, or handled computer, e.g., a Personal Digital Assistant (PDA) or handheld gaming console with communication capability.

Terminal 102 includes a standard input device 104 through which a token 106 can be interfaced with terminal 102. For purposes of this specification and the claims that follow, the term “standard input device” means a standard, or widely adopted device for inputting, or transferring information into a particular type of terminal 102. Thus, for example, if terminal 102 is a personal computer, then standard input device 104 can be a floppy drive, a Compact Disc (CD) drive, a CD Read/Write (R/W) drive, a Digital Video Disc (DVD) drive, or any other type of drive that is commonly included, or interfaced with a personal computer.

Token 106 is, therefore, a physical device, such as CD media, USB storage, or compact flash, etc., that can be interfaced with terminal 102 through standard input device 104. Some specific token embodiments are described in detail below. Token 106 is configured to allow authentication authority 110 to verify the presence of token 106, through network 108, once it is interfaced with terminal 102 through standard input device 104.

An input device, the only purpose of which is to allow a token, such as token 106, to be interfaced with a terminal, such as terminal 102, to enable an online transaction is expressly not included in the definition of the term “standard input device.” The point being that the systems and methods described herein do not require the cost, integration, or maintenance of specialized hardware in order to ensure a high level of authentication for online transactions. Rather, the systems and methods described herein allow the use of standard equipment to achieve high level authentication.

Thus, authentication authority 110 can be configured to verify the presence of token 106 if terminal 102 is engaged in a transaction that requires authentication. Authentication authority 110 can, depending on the embodiment, include or be interfaced with an authentication database 112 configured to store information related to a plurality of tokens 106. The information stored in authentication database 112 can then be used to authenticate transactions involving the plurality of tokens' 106. For example, if token 106 comprises credit card information, then authentication database 112 can be configured to store valid credit card numbers. Authentication authority 110 can be configured to then verify both the presence of token 106 and the validity of a credit card number stored thereon.

Additionally, the person using terminal 102 can be required to provide a personal identifier, such as a PIN. In which case, information stored in authentication database 112 can also be used to verify the personal identifier provided. Thus, authentication authority 110 can be configured to supply two-factor authentication for electronic transactions involving terminal 102.

Verification of other factors can also be incorporated to provide even stronger multi-factor authentication. For example, if terminal 102 includes a biometric reader, such as a fingerprint sensor, then verification of a biometric can also be incorporated to provide multifactor authentication. Further, other authentication techniques can be included such as digital signature techniques or other public key-private key techniques.

Before authentication authority 110 can authenticate a token 106, however, the personal identifier, e.g., PIN, should be “linked” with authentication information available in, for example, a database such as authentication database 112. The process of linking the personal identifier with the account information can be referred to as an enrollment process. Preferably, enrollment is seamless from the point of view of the user. In other words, enrollment should occur or be initiated automatically, without requiring the user to affirmatively decide to enroll. And once the enrollment process starts, it should be quick, efficient and cause as little inconvenience as possible.

Because network 108 can be an unsecured network, e.g., the Internet, communications sent from terminal 102 to authentication authority 110 can be intercepted by an unintended party. For added security, communications between terminal 102 and authentication authority 110 can be encrypted.

Distribution of tokens 106 can be handled, or initiated, by an issuing authority such as a bank can distribute token 106. For reasons described in co-pending U.S. patent application Ser. No. 10/347,114, token 106 often is not associated with a user until enrollment takes place. FIGS. 2-9 of the '114 application described various exemplary systems and methods for enrolling, authenticating and using a token.

As described above, token 106 can be any type of media that can be interfaced with terminal 102 through standard input device 104, The more ubiquitous the standard input device, the more likely token 106 will be adopted by the user. CD drives or their successors such as CD RIW drives, DVD ROM drives, and DVD±RIW drives are so ubiquitous that most personal computers come equipped with a CD compatible drive as a standard peripheral.

In one embodiment, token 106 can be a CD media that can be interfaced with terminal 102 through a CD drive. FIG. 2 shows an embodiment of token 106 as a mini-CD 200. The dimensions and properties of a mini-CD are well known in the art. Typical CD drives mount the mini-CD using hole 210. One aspect, of mini-CD 200 that can vary from implementation to implementation is the location of hole 210. Often, hole 210 is located in the middle of mini-CD 200. In other embodiments such as shown in FIG. 2, hole 210 can be offset from the center.

Mini-CD 200 can include CD data on one side that can be read by a CD drive. The data capacity can be as high as 50 Megabytes (Mb), providing ample capacity to store the data required for enrollment and authentication as described for system 100. The typical capacity in mini-CD 200 can additional provide capacity to store advertising information, or other information which can be displayed to the user on terminal 102. Other information can include links to resources on a network such as hypertext links to webpages over the Internet. As described below, certain physical embodiments of token 106 can result in a more limited data capacity; however, clearly some minimum capacity will be needed. When the physical configuration reduces the capacity too much then the track pitch and/or scan velocity can be altered in order to obtain the requisite capacity.

To reduce the number of tokens a user must carry and keep track of, it is desirable to use token 106 for offline transactions in addition to online transactions. Because card readers are by far the most common standard interfaces in offline transaction, token 106 should be configured to be readable by a standard card reader. Unfortunately, a typical mini-CD is to thick to fit into a standard card reader; however, if mini-CD 200 is made thinner, conventional CD drives may have difficulty reading mini-CD 200.

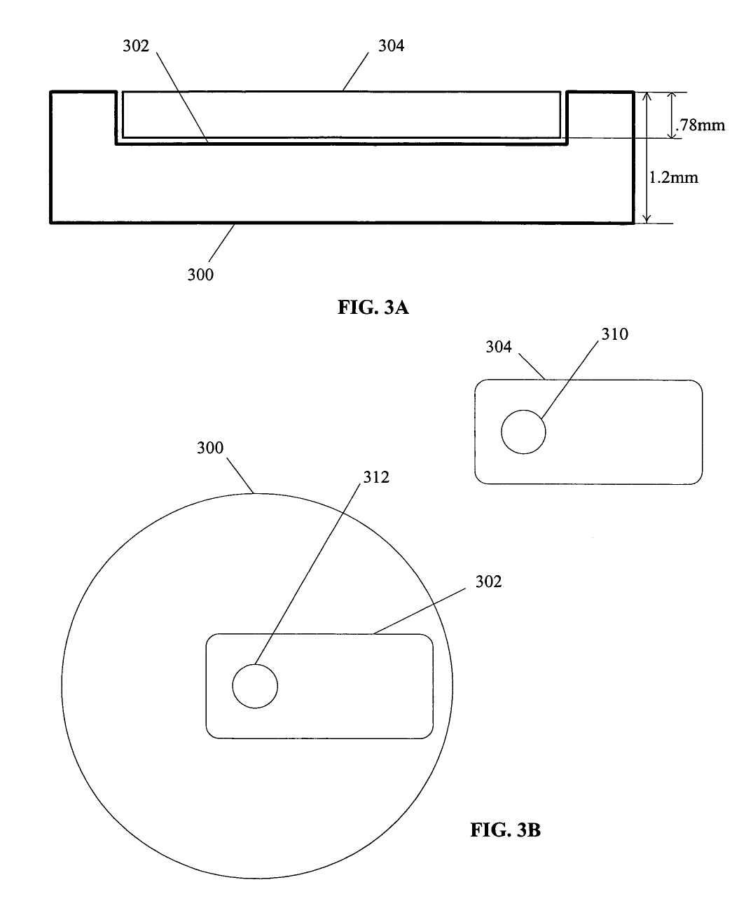

FIG. 3A and FIG. 3B are a side view and a top view an embodiment of token 106 which comprises thin mini-CD 304 which is capable of being read by standard card readers. For example, thin mini-CD 304 can be made compatible with the ISO 7811 standard for plastic, e.g., credit cards. Therefore, thin mini-CD 304 can work in ATM machines as well as conventional credit card readers and Point-of-Sale (POS) terminals. Thin mini-CD 304 depicted in FIG. 3 has a thickness of approximately 0.78 millimeters (mm), which is too thin to be reliably read by conventional CD drives.

In order to make thin mini-CD 304 compatible with conventional CD drives, token 106 comprises carrier 300 for thin mini-CD 304. Carrier 300 has cutout 302 shaped to receive thin mini-CD 304. Once thin mini-CD 304 is seated into carrier 302, the token can be loaded into a conventional CD drive. The thickness of thin mini-CD 304 and carrier 300 when assembled together can be made to equal that of a standard CD, i.e. 12 mm.

Referring to the top view shown in FIG. 3B, both carrier 300 and mini-CD 304 comprise a hole for receiving the spindle of a CD drive. Though depicted as circular, the shape of carrier 300 can be any shape which can properly fit into a CD drive. The location of cutout 302 can vary depending on the embodiment of thin mini-CD 304. Cutout 302 can be centered especially when hole 310 of thin mini-CD 304 is in the center. If hole 310 is off-center, cutout 302 should be located so that hole 310 is aligned with hole 312 of carrier 310.

An embodiment of mini-CD 304 where hole 310 is off-center can be used to accommodate a smart card chip, so that thin mini-CD 304 can be configured to work in a smart card reader as well as a CD drive. In order to comply with smart card standards, thin mini-CD 304 can be designed to accommodate a smart card chip of standard dimensions. If hole 310 were centered, there may not be enough room to accommodate a smart card chip on thin mini-CD 304. Therefore, hole 310 can be placed off-center to allow room to accommodate a smart card chip.

In order for mini-CD 304 to work in a standard card reader that are configured to read magnetic strips, thin mini-CD 304 can comprise a magnetic strip. Depending on the dimensions of the magnetic strip required, hole 310 can be placed in a different location allowing sufficient space on thin mini-CD 304 to accommodate the magnetic strip.

In other offline transactions, a merchant can require that a card or token have embossed lettering comprising information related to the users, such as an account identifier. This is often used in imprinting the card or token in certain situations. However, typical embossing techniques used in credit card manufacture can not be used on thin mini-CD 304, because typical embossing is achieved from the underside of the card or token and extending through the upper side. Such a process would render thin mini-CD 304 unusable on a typical CD drive because the CD readable data region would be damaged.

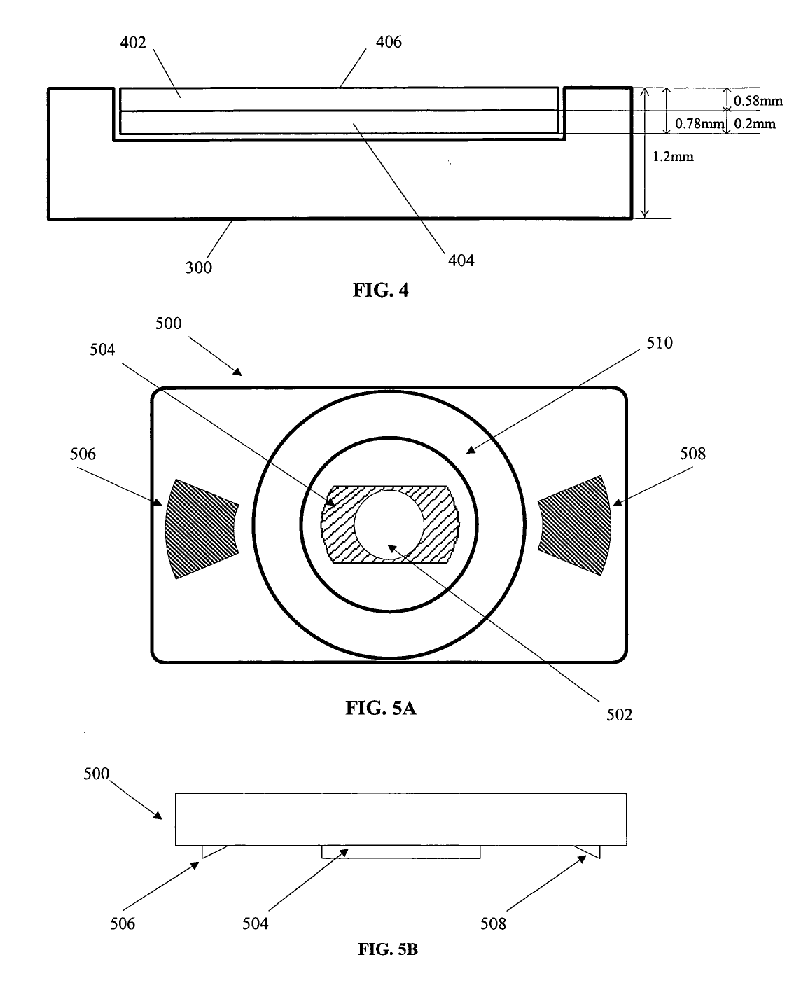

FIG. 4 illustrates an embodiment of a thin mini-CD 406 that comprises multiple laminate layers 402 and 404 so that thin mini-CD 406 can in fact be embossed. In this embodiment, top layer 402 is embossed as required. Layer 404 includes the CD readable data. The two layers are then laminated to form a thin mini-CD 406 that can be read by a conventional CD drive using carrier 300 for example, as well as conventional card readers including smart card readers if needed, an also includes embossing. In the embodiment of FIG. 4, embossing layer 402 is typically 0.5 mm thick and CD data layer 404 is 0.28 mm thick so that combined, they are 0.78 mm thick just like thin mini-CD 304.

While the embodiment of the token depicted in FIGS. 3 and 4 bridge the physical discrepancies between standard offline tokens, i.e. cards and online tokens, i.e. CD readable media, the need for a carrier to accommodate a thin mini-CD can prove inconvenient for the user. A user might carry the thin mini-CD in his wallet, but store the carrier near his computer. The chances the carrier gets lost or is not available at the time he wishes to transact online only underscores the inconvenience to the user.

The following embodiments illustrate a single token which can be used in both standard card readers and standard CD readers.

FIG. 5A and FIG. 5B are the top view and side view of a dual function payment card 500 configured in accordance with the systems and methods described herein. Card 500 can be read by both a standard optical input device, i.e. CD drive or its successors without the need for a separate carrier, as well as standard card readers. Card 500 can comprise the standard footprint dimensions, e.g. 3⅜″×2⅛″, of common payment cards. It can also include a magnetic strip that can be read by common magnetic stripe readers. Therefore, it has the paint-of-purchase functionality and convenience of a standard payment card. Card 500 is additionally configured with digital optical storage media and physical alignment features that make it readable by a typical optical input device.

As an optical medium, card 500 can be inserted into a computer's optical input device tray or drawer which then reads the digital information contained in the optical media. Included in the optical media data can be a unique digital certificate, signature, token, identification number or the like that can be used to verify physical possession of the card by the user. The optical media can also contain bootstrap and applications software that facilitate the verification process or related functions, and optionally additional cardholder personalization data that enhance the functionality of the card. The result is an optical payment card (OPC) with all the features and convenience of a standard payment card, plus the ability to facilitate secure interactive E-Commerce transactions through most any Internet connected computer or computing device that comprises an optical drive.

In the embodiment of the OPC shown in FIGS. 5A and 5B, the peripheral dimensions of card 500 match those of a standard payment card, and card 500 also includes hole 502, which is centrally located and, in one embodiment, 15 millimeters in diameter. This diameter corresponds to that found on current standard optical media disks. Region 510 is the optical information area, which is configured as optical storage media where optical data associated with use of the token can be stored. Because region 510 can be a larger region than presented in the optical information area of a standard 80 mm mini-disk, the data capacity of card 500 can be greater. Specifically, in CD-ROM format, this region can be capable of storing approximately 80 megabytes (MB) of data and over 500 MB of data if written in DVD data format.

As mentioned above, in some embodiments, the physical dimensions of Card 500 can result in an optical information area 510 that does not have sufficient capacity if standard track pitch and scan velocity are used. In such situations, the track pitch and scan velocity can be altered in order to provide adequate capacity. For example, in one embodiment, it was determined that at least 10 Mb of capacity was required for region 510; however, the physical dimensions of region 510 did not produce 10 Mb of capacity when standard track pitch and scan velocity was used. In order to overcome this issue, the track pitch and scan velocity were changed to produce at least 10 Mb of capacity in region 510.

Scan velocity can be changed by changing information stored in region 510. It will be understood that regions on a standard optical disk include information that can be read by the disk drive and that tell the drive what scan velocity to use. Thus, by altering this information one scan velocity can be changed.

In a standard optical media a centrally located hole enables mechanical centering of the disk in an optical input device. In order for the drive to initially engage the central hole, the disk should be approximately centered in the drive tray. Drive trays typically include two concentric indentations for positioning either standard 120 mm disks, or 80 mm “mini disks”. When the drive tray closes, the drive mechanism engages the 15 mm central hole and clamps the disk in the annular region lying between diameters of 29 mm and 31 mm . If the disk is not initially reasonably well centered in the tray, the clamping mechanism can damage the disk or fail to correctly operate. Card 500, in maintaining physical compatibility with standard optical input devices, can include hole 502, and a reliable mechanism for initially centering the card in the optical input device tray

The centering function can be accomplished using the two raised fairings 506 and 50K. The two centering fairings are dimensioned to nest inside the smaller 80 mm mini-disk indentation, thereby centering the card in the tray. In addition to the two centering fairings 506 and 508, third raised portion 504 is provided on the bottom surface at the center of the card. The height, or vertical position, of the optical media is an offset to by the bottom surface of the media in the clamping region. Thus, raised portion 504, which is located between the inner hole and the outer perimeter of the annular clamping area, serves to set the card at the correct height to allow the optical stylus of the optical input device to focus on the data surface of the information area. Raised portion 504 can be used to compensate for the difference in thickness between a standard payment card, which has a thickness of 0.76 mm and that of a standard optical media disk, which has a thickness of 1.20 mm .

Raised portion 504, serves an additional important function in regard to the clamping function of the optical drive. Specifically, the standard optical drive is designed to engage a clamping area that is nominally 1.2 mm thick. The thickness increase of about 0.4 mm to card 500 due to raised region 504 ensures more reliable clamping, as well as being beneficial to the overall rigidity ruggedness of the card. Raised region 504 properly includes at least a portion of the annular clamping region lying between diameters of about 25 mm and 31 mm . The shape of raised region 504 can be annular in shape, a truncated annulus as shown in FIG. 5, or some other convenient shape as deemed appropriate, but which accomplishes the two main fictions of providing optical compatibility, which is described later, and providing mechanical compatibility with the optical drive clamping system. It should be noted that the contours introduced by fairings 506 and 508 and raised portion 504 have a height on the order of a fraction of a millimeter which is commensurate with the height of embossed characters on a typical credit card. As a result, Card 500 is compatible with card readers such as credit card or ATM card readers as mentioned above.

Accordingly, fairings 506 and 508, as well as raised portion 504, and their specific dimensions and contours, allow card 500 to work in an optical drive as well as POS terminals. Thus, these features and their dimensions and contours allow strong two factor authentication in both the online and POS environments.

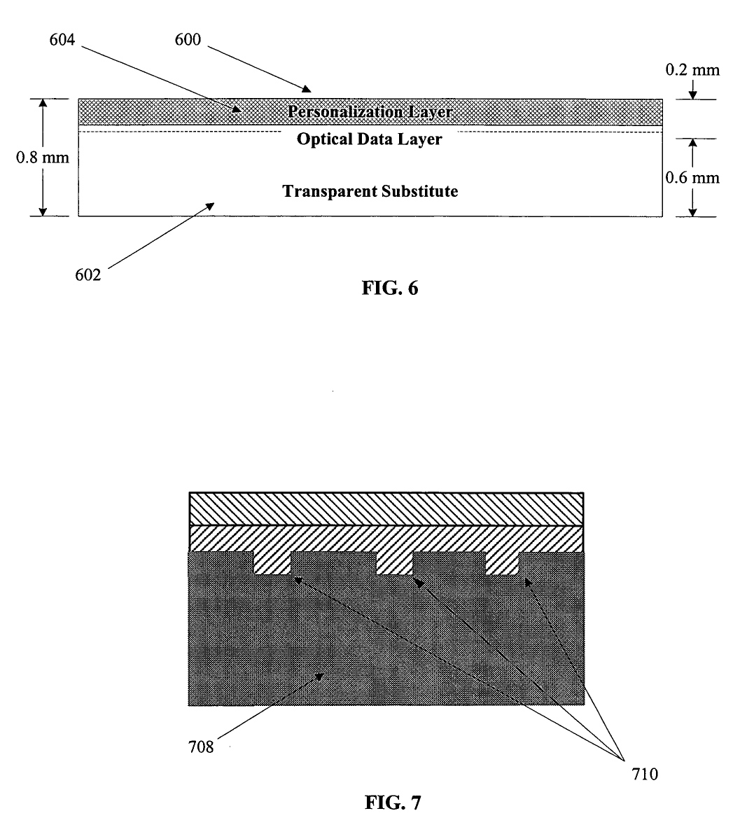

FIG. 6 is a cross-sectional view of another embodiment of an OPC. OPC 600 comprises two layers, an approximately 0.6 mm thick transparent optical media layer 602 and an approximately 0.2 mm thick “personalization” layer 604 that can contain a magnetic stripe and embossed raised lettering, or other identification and anti-counterfeiting features often found on a typical payment card. The two layers 602 and 604 can be permanently laminated together to produce a standard 0.76 mm thick payment card. But it is understood that the individual and combined dimensions of layers 602 and 604 are such as to allow OPC 600 to function in a standard optical drive as well as conventional point of sale devices. Furthermore, OPC 600 can incorporate the spacing and centering features found in the embodiment described in FIG. 5.

A magnetic strip can be deposited on personalization layer 604 using conventional techniques; however, in certain embodiments, the magnetic stripe can be printed onto layer 604 using printing techniques and conductive ink.

In addition to physical compatibility, card 500 and OPC 600 incorporates features to maintain optical compatibility with a standard optical disk. To illustrate the issues related to optical compatibility, an explanation of the operation of a standard optical media disk follows.

FIG. 7 shows a cross-section of a standard optical media disk. A transparent substrate 708,. typically a polycarbonate plastic, has an industry standard thickness of 1.2±0.1 mm. The upper surface of the information region contains a series of pits 610 that represent the digital information. These pits are typically about 0.5 pm (10⁻³ mm) wide and lie on a single spiral data track. These data pits are read by an optical stylus, which consists essentially of a highly focused laser beam and optical detection system. For the laser beam to focus on the pits, its correct focal distance should be accurately maintained. Optical stylus systems used in optical input devices include means for dynamically adjusting the laser position for accurate focus as the disk spins.

To compensate for radial run-out error due to disk warp, etc., industry standards require automatic focal distance compensation for vertical variations of up to ±0.35 mm from the nominal reference plane. Though the thickness of card 500 falls within this industry tolerance, it lies at the edge of the tolerance range which means without compensation card 500 will have little tolerance for disk warp and other factors. Furthermore, this would limit operable embodiments of card 500 be no thinner than about 0.85 mm , for example, OPC 600 would lie outside the tolerance range of the industry standard.

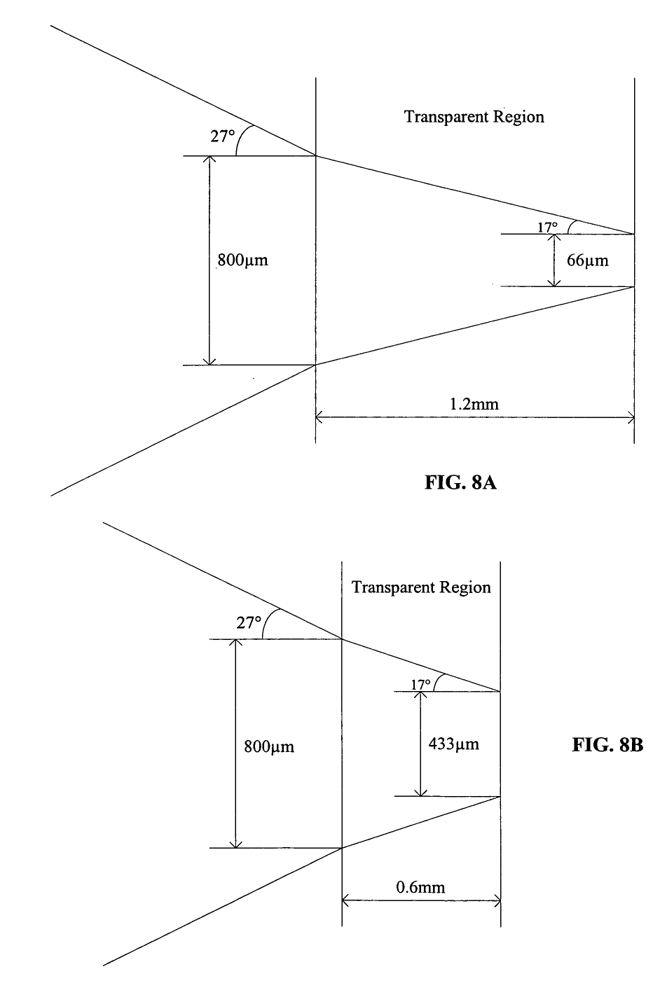

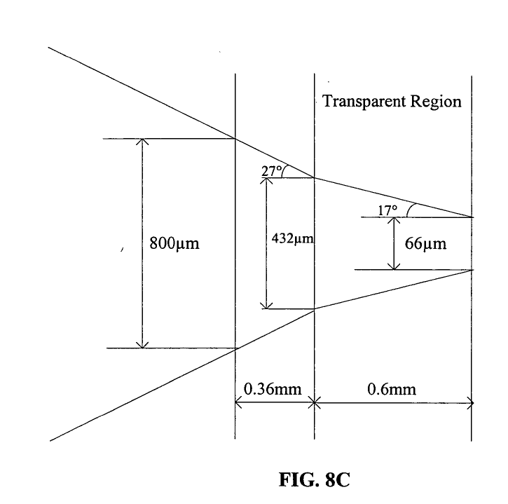

FIG. 8A shows a diagram of an optical stylus system in a standard optical disk medium. The spot size of the laser beam incident upon the medium is 800 μm and the incident beam has an outer slope of 27°. Upon being refracted by the transparent region of the optical medium, the beam is transformed to one with an outer slope of 17° which can be calculated using Snell's law. Using ray geometry analysis, the spot size is determined to be 66 μm upon traversal of the transparent region of thickness 1.2 mm.

FIG. 8B shows a diagram of an optical stylus system where a thin optical disk medium is used. As an example, a medium of 0.6 mm transforms the 800 μm incident spot size to a 433 μm spot size. Depending on the spacing of the pits in the information region, the system can have trouble resolving each individual bit in the information region. Depicted is a transparent region with a thickness of 0.6 mm. This corresponds to an embodiment of OPC 600. As for a transparent region with a thickness of 0.76 mm, which corresponds to card 500, the spot size would be transformed to about 336 μm.

FIG. 8C shows a diagram of an optical stylus system where a thin optical disk medium is used. By displacing the medium away from the normal plane of incidence, the incident spot size is reduced. Upon traversal through air of an extra 0.36 mm, the incident spot size of 800 μm is reduced to 432 μm. This spot size is transformed to the spot size of 66 μm upon traversal of the transparent region of thickness 0.6 mm. In relation to the card of thickness 0.76 mm, an offset of 0.32 mm reduces the incident spot size to 530 μm. The spot size is transformed to a spot size of 66 μm upon traversal of the transparent region of thickness 0.76 mm.

In order to compensate for the focal spot size variations resulting from the difference in thicknesses in card 500 or OPC 600 compared to standard optical media disks, raised portion 504 can be designed to provide the appropriate offsets as described above, which sets the nominal height of the data pit layer to lie near the center of the focal range of the optical stylus. Setting the proper card height allows the laser beam tracking system to accurately focus over an acceptable range of height variation as card 500 or OPC 600 spins in the optical drive.

The ray geometry analysis shown in FIG. 8 explains how optical difference due to the thickness can compensated for by adding additional space between the laser and the surface of the card. This analysis assumes that the laser beam focuses along a straight focal line as is widely thought. This is reinforced by the fact that the applicable manufacturers specifications and standards often state explicitly, that the layers of a conventional CD or DVD focus the laser beam to a focal point along a straight focal line. However, in practice the focal point is often found to be off centered, perhaps due to aberrations in the optics of the system and slight misalignment of the mechanical parts.

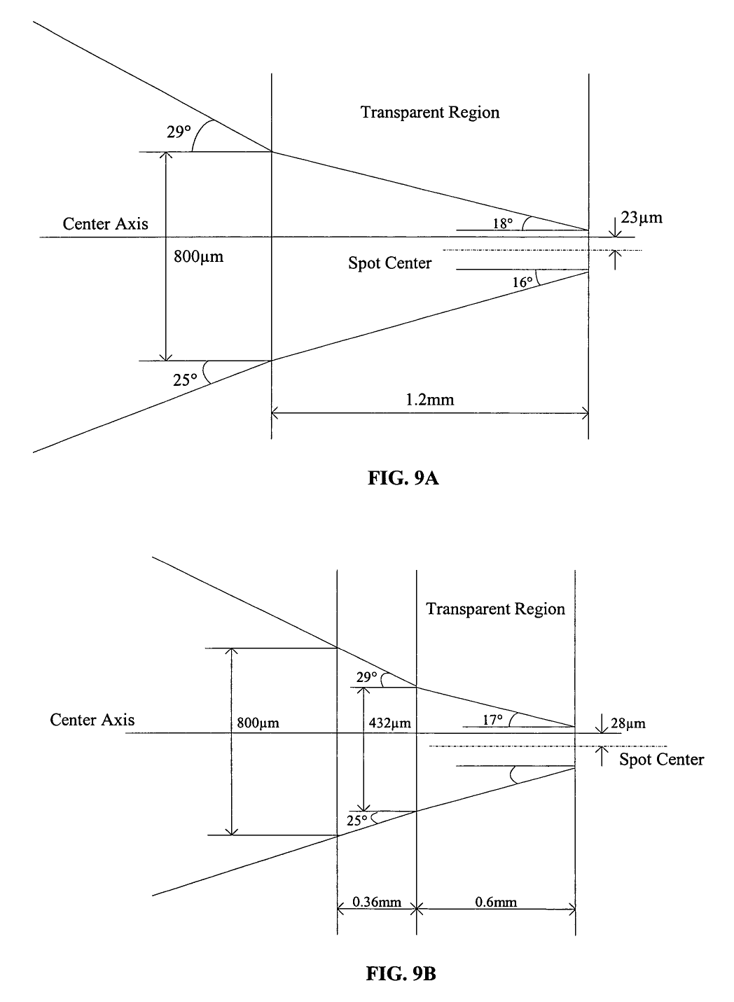

FIGS. 9A and 9B shows a diagram of how the focal points can be offset. FIG. 9A shows a standard optical disk of thickness 1.2 mm. The incident beam is 2° off the straight focal line. The result is approximately a 23 μm displacement of the focal point (fₚ) from the center axis. FIG. 9B shows an embodiment of OPC 600 with a transparent region of thickness 0.6 mm, with height compensation, and with the same incident beam. The result is a displacement of the focal point (fₚ) of approximately 28 μm. Typically, this discrepancy is well within the tolerance of most optical drives.

It is important that the exposed surface of the transparent substrate be of reasonable optical quality, which includes remaining relatively scratch free. By reducing the spot size incident on the card due to height compensation, for example, for OPC 600, the spot size is reduced from 800 μm to 432 μm, the effect of localized scratches is increased. Furthermore, the OPC is likely to incur more frequent handling and the attendant opportunity for scratching than is typical for a CD or DVD disk. On the other hand, it is well known that polycarbonate is a relatively soft polymeric material that is rather susceptible to scratching. To mitigate this problem, an embodiment of the OPC can have a hard coating applied to the transparent substrate surface by any of several means commonly used for this purpose, for example in the manufacture of eyeglass lenses. Materials commonly used to hard coat lenses include organo-siloxane colloidal silica compounds, cross-linked acrylics, or diamond-like films. The materials and methods for applying hard coatings to plastic surfaces in general and polycarbonate in particular are well known in the lens manufacturing art and are directly applicable in the present context. The thickness of such a coating typically does not need to exceed a few microns. A coating material of low refractive index can be used to reduce reflection, which is about 5% from an uncoated polycarbonate surface (n=1.55). As is well understood and widely practiced in the lens coating art, optical interference coatings can also be applied to optical surfaces, which would serve the dual purpose of reducing reflection while also improving resistance to scratching. Such coatings would also add the visual aspect of a colored appearance, which could enhance the aesthetic appeal of the card and help thwart counterfeiting.

The optical information area of the OPC can conform to current standards for CD and DVD optical media in terms of physical structure and composition as well as digital encoding schemes. Encoding is in the form of digital tracks that can be either data tracks or a combination of data and audio tracks. In addition to the user writable digital tracks, there are also required to be lead-in and lead-out tracks that contain information regarding the format and content of the user digital data. Various error correction techniques, including parity checking and data interleaving, are used when writing the data tracks to improve the robustness of the read-out process. In simple terms, a bit is represented by the transitions at the edges of pits in the spiral data tracks. Data pits are normally pressed into the upper surface of the transparent substrate as part of the overall fabrication process, usually by injection molding. This manufacturing technique is appropriate for mass production of a identical disk, but is not well suited to the present application where it is necessary to embed unique certificates or identification information and may be desirable to include personalized information unique to the individual card holder.

Writeable optical media can be used. With this newer technology, a laser beam is used to write the equivalent of pits into an organic dye layer. The “pits” formed by laser heating of the dye layer alter the reflectivity of very small regions of such media allowing the disk to be read by a standard optical drive. Optical drives or “burners” capable of writing data onto writeable or re-writeable media in either CD or DVD format or both have now become quite popular as are the media they use. The OPC can make use of one of these media types in its information area for the added the convenience and utility associated with writeable and re-writeable optical media. Once the data is written to the information region of the card, it may be desirable to prevent further data writing, which can be accomplished by write-protecting some portion of the media by a method that is widely known in the industry and which is a standard option that can be invoked with most of the popular software applications used in conjunction with CD and DVD burners. The increasing popularity of optical burners on home and business computers opens up the further possibility of use this feature to write information to the OPC during transactions so as to enable much of the functionality of smartcards with writeable memory.

Copy protection of optical disks is an important issue that has received extensive attention throughout the computer software and entertainment industries. This is an issue that has particular relevance in the present context, since it would generally be undesirable for a third party to be able to read and copy the contents of an OPC and to thereby fraudulently acquire its functionality and unique identity. Various schemes for copy protection are currently being used with varying degrees of success for protecting commercial software programs, games, and music CD's. Content Protection for Recordable Media (CPRM) is an industry standard copy protection scheme that thwarts copying to other media by tying a recording to the media on which it is recorded. The method is based on a unique 64-bit media ID etched in the Burst Cutting Area (BCA), which is a zone near the disk hub that is reserved for a barcode that can be etched into-the disc by a high-powered laser. Because barcode cutting is independent of the stamping process, each disc can have unique data recorded in the BCA, such as a serialized ID. When protected content is recorded onto the disc, it can be encrypted, for example with a 56-bit C2 (Cryptomeria) cipher, derived from the media ID. During playback, the ID can be read from the BCA and used to generate a key to decrypt the contents of the disc. If the contents of the disc are copied to any other media, the ID will be absent or incorrect and the data will not be decrypted.

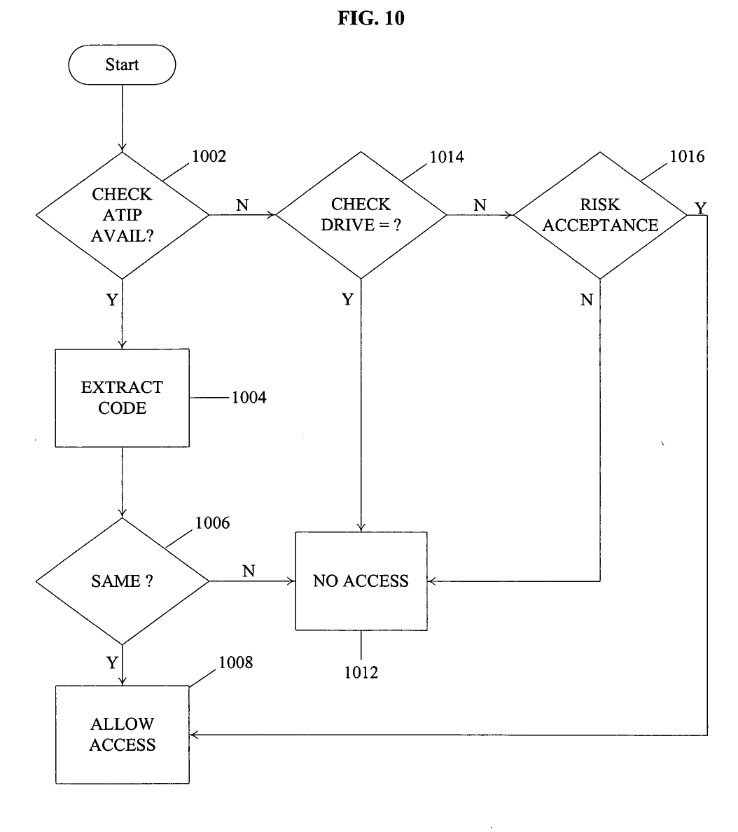

Alternatively, a code can be included in the Absolute Time In Pregroove (ATIP) area of the optical media in region 510. In such an embodiment, the code may not be available to all optical drives. For example, currently the code would be available to CD-R/CD-RW, DVD±R, and DVD±RW drives, but not necessarily to all CD-ROM drives. Accordingly, the method depicted in the flowchart of FIG. 10 can be used to implement copy protection using a code embedded in the ATIP area, or equivalent, in accordance with one embodiment of the systems and methods described herein.

First, in step 1002, terminal 102 can be configured to check whether the ATIP exists and is readable. If the ATIP is readable, then in step 1004, the code stored therein can be extracted. The extracted code can then, in step 1006, be compared with the stored, or known code. If the codes match, then normal processing of the payment or other transaction can proceed. If the code is not the same, then in step 1012 processing of the transaction can be ended.

If the ATIP is not present and/or not readable, then the drive type can be checked to see if the ATIP should be present in step 1014. For example, currently, if the drive type is a CD-R, CD-RW, DVD-ROM, DVD-RAM, DVD±RW RO, or A DVD±RW SR, then the ATIP should be present. If it is not, or of it is not readable, then this can be considered and indication that the inserted card is a copy, or counterfeit. In which case, processing can be ceased in step 1012.

If it is determined in step 1014 that the drive is, e.g., a CD-ROM, however, then an ATIP normally is not present. In this case, risk that the card is copied needs to be managed. Thus, in step 1016, it can be determined whether the risk is acceptable. If the risk is acceptable, then processing can continue in step 1008. Otherwise, processing can be ended in step 1012. In one embodiment for example, processing can always be allowed to continue when the ATIP is not expected top be present. At the other extreme, processing can always be ended. In other embodiments, however, some intermediate action is taken to assess the risk. For example, different authentication techniques can be used, or the authentication profile can be changed, or lowered to take into account the inability to verify the code, or that the card is not a copy.

Other protection schemes include embedding a digital “watermark” or requiring the user to manually enter a Personal Identification Number (PIN) to carry out a transaction. The preceding copy protection methods presented here are by way of example only. Any copy protection method that is developed for conventional optical media disks can be adapted to the OPC. No doubt as technology improves to provide better copy protection and combat new threats, new methods will evolve which can be incorporated into OPC's.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. A method for copy protection of data contained on an optical payment card, comprising:
determining whether the optical payment card includes an absolute time in pregroove;
when it is determined that the absolute time in pregroove is present, extracting a code form the absolute time in pregroove;
comparing the extracted code with a known code; and
allowing a transaction to proceed when the extracted code matches the known code.

2. The method of claim 1, further comprising ending the transaction when it is determined that the extracted code does not match the known code.

3. The method of claim 1, further comprising determining what kind of optical drive is being used when it is determined that the absolute time in pregroove is not present.

4. The method of claim 3, further comprising determining whether the optical payment card should include an absolute time in pregroove based on the determined optical drive.

5. The method of claim 4, further comprising ending the transaction when it is determined that the optical payment card should include an absolute time in pregroove.

6. The method of claim 4, further comprising allowing the transaction to continue when it is determined that the optical payment card should not include an absolute time in pregroove.

7. The method of claim 4, further comprising terminating the transaction when it is determined that the optical payment card should not include an absolute time in pregroove.

8. The method of claim 4, further comprising allowing the transaction to continue and lowering an authentication risk profile when it is determined that the optical payment card should not include an absolute time in pregroove.

9. The method of claim 4, further comprising initiating a secondary authentication when it is determined that the optical payment card should not include an absolute time in pregroove.

10. An online transaction system, comprising:
an optical payment card; and
a terminal comprising a standard optical drive configured to receive the optical payment card and a processor, the processor configured to:
determine whether the optical payment card includes an absolute time in pregroove;
extract a code form the absolute time in pregroove when it is determined that the absolute time in pregroove is present;
compare the extracted code with a known code; and
allow a transaction to proceed when the extracted code matches the known code.

11. The system of claim 10, wherein the processor is further configured to end the transaction when it is determined that the extracted code does not match the known code.

12. The system of claim 10, wherein the processor is further configured to determine a type for the optical drive when it is determined that the absolute time in pregroove is not present.

13. The system of claim 12, wherein the processor is further configured to determine whether the optical payment card should include an absolute time in pregroove based on the determined optical drive.

14. The system of claim 13, wherein the processor is further configured to end the transaction when it is determined that the optical payment card should include an absolute time in pregroove.

15. The system of claim 13, wherein the processor is further configured to allow the transaction to continue when it is determined that the optical payment card should not include an absolute time in pregroove.

16. The system of claim 13, wherein the processor is further configured to terminate the transaction when it is determined that the optical payment card should not include an absolute time in pregroove.

17. The system of claim 13, wherein the processor is further configured to allow the transaction to continue and lower an authentication risk profile when it is determined that the optical payment card should not include an absolute time in pregroove.

18. The system of claim 13, wherein the processor is further configured to initiate a secondary authentication when it is determined that the optical payment card should not include an absolute time in pregroove.
